(19) United States
(12) Patent Application Publication
(10) Pub. No.: US 2025/0315346 A1
(43) Pub. Date: Oct. 9, 2025

(54) DISTRIBUTED SNAPSHOT POLICY SCHEDULE

(71) Applicant: Dell Products L.P., Round Rock, TX (US)

(72) Inventors: Sandeep Chandrashekhara, Shrewsbury, MA (US); Ramesh Doddaiah, Westborough, MA (US); Mohammed Asher, Bangalore (IN); Mohammed Aamir VT, Bangalore (IN)

(73) Assignee: Dell Products L.P., Round Rock, TX (US)

(21) Appl. No.: 18/630,253

(22) Filed: Apr. 9, 2024

(51) Int. Cl. G06F 11/14; G06F 3/06

(52) U.S. Cl. CPC G06F 11/1446; G06F 3/0604; G06F 3/0653; G06F 3/067; G06F 2201/84

(57) ABSTRACT

A method for creating snapshots is disclosed. The method includes collecting a first resource usage metric of a first storage system and a second resource usage metric for one or more second storage systems, detecting a command to create a snapshot of a storage entity, and detecting when the snapshot would be a base snapshot. When the snapshot is going to be a base snapshot, a selection policy is evaluated to identify the location where the snapshot is going to be created after which the snapshot is created at the identified location. When the snapshot would not be a base snapshot, the snapshot is stored at a location where snapshots of the storage entity are already being created.

### BACKGROUND

A distributed storage system may include a plurality of storage devices (e.g., storage arrays) to provide data storage to a plurality of nodes. The plurality of storage devices and the plurality of nodes may be situated in the same physical location, or in one or more physically remote locations. The plurality of nodes may be coupled to the storage devices by a high-speed interconnect, such as a switch fabric.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

According to aspects of the disclosure, a method is provided, comprising: collecting a first resource usage metric of a first storage system, the first storage system being configured to store a copy of a storage entity, the storage entity being a volume or a storage group; receiving a respective second resource usage metric for each of one or more second storage systems, each of the second storage systems also being configured to store a copy of the storage entity; detecting, at the first storage system, a command to create a given snapshot of the storage entity; detecting whether the given snapshot would be a base snapshot; evaluating a selection policy to select one of the first and the second storage systems as a location where the given snapshot should be created, the selection policy being evaluated based on the first and second resource usage metrics, the selection policy being evaluated when the given snapshot would be a base snapshot; identifying one of the first and second storage systems as a storage system where snapshots of the storage entity are already being taken, and selecting the identified one of the first and second storage systems as the location where the given snapshot should be created, the identifying being performed when the given snapshot would not be a base snapshot; and generating the given snapshot by one of the first storage system and the second storage systems that is selected as the location where the given snapshot should be created.

According to aspects of the disclosure, a computing device is provided, comprising: a memory; and at least one processor that is operatively coupled to the memory, the at least one processor being configured to perform the operations of: collecting a first resource usage metric of a first storage system, the first storage system being configured to store a copy of a storage entity, the storage entity being a volume or a storage group; receiving a respective second resource usage metric for each of one or more second storage systems, each of the second storage systems also being configured to store a copy of the storage entity; detecting, at the first storage system, a command to create a given snapshot of the storage entity; detecting whether the given snapshot would be a base snapshot; evaluating a selection policy to select one of the first and the second storage systems as a location where the given snapshot should be created, the selection policy being evaluated based on the first and second resource usage metrics, the selection policy being evaluated when the given snapshot would be a base snapshot; identifying one of the first and second storage systems as a storage system where snapshots of the storage entity are already being taken, and selecting the identified one of the first and second storage systems as the location where the given snapshot should be created, the identifying being performed when the given snapshot would not be a base snapshot, wherein the given snapshot is created by one of the first and second storage systems that is selected as the location where the given snapshot should be created.

According to aspects of the disclosure, a non-transitory computer-readable medium storing one or more processor-executable instructions, which, when executed by at least one processor, cause the at least one processor to perform the operations of: at least one processor that is operatively coupled to the memory, the at least one processor being configured to perform the operations of: collecting a first resource usage metric of a first storage system, the first storage system being configured to store a copy of a storage entity, the storage entity being a volume or a storage group; receiving a respective second resource usage metric for each of one or more second storage systems, each of the second storage systems also being configured to store a copy of the storage entity; detecting, at the first storage system, a command to create a given snapshot of the storage entity; detecting whether the given snapshot would be a base snapshot; evaluating a selection policy to select one of the first and the second storage systems as a location where the given snapshot should be created, the selection policy being evaluated based on the first and second resource usage metrics, the selection policy being evaluated when the given snapshot would be a base snapshot; identifying one of the first and second storage systems as a storage system where snapshots of the storage entity are already being taken, and selecting the identified one of the first and second storage systems as the location where the given snapshot should be created, the identifying being performed when the given snapshot would not be a base snapshot, wherein the given snapshot is created by one of the first and second storage systems that is selected as the location where the given snapshot should be created.

### BRIEF DESCRIPTION OF THE DRAWING FIGURES

Other aspects, features, and advantages of the claimed invention will become more fully apparent from the following detailed description, the appended claims, and the accompanying drawings in which like reference numerals identify similar or identical elements. Reference numerals that are introduced in the specification in association with a drawing figure may be repeated in one or more subsequent figures without additional description in the specification in order to provide context for other features.

FIG. 1 is a diagram of an example of a system, according to aspects of the disclosure;

FIG. 2 is a diagram of an example of a storage system, according to aspects of the disclosure;

FIG. 3 is a snapshot location table, according to aspects of the disclosure;

FIG. 4 is a flowchart of an example of a process, according to aspects of the disclosure;

FIG. 5 is a flowchart of an example of a process, according to aspects of the disclosure;

FIG. 6 is a diagram of an example of a computing device, according to aspects of the disclosure.

### DETAILED DESCRIPTION

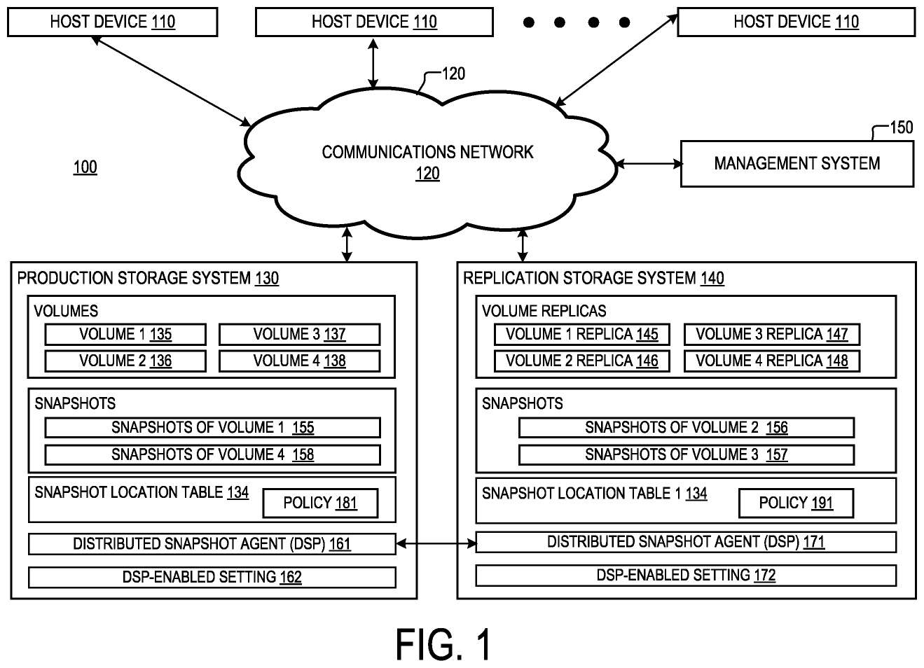

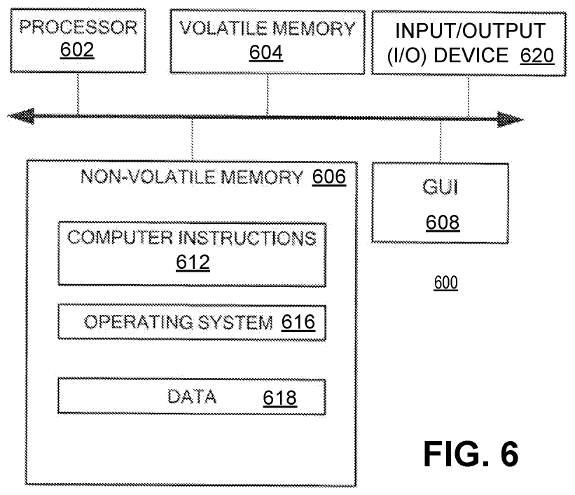

FIG. 1 is a diagram of an example of a system 100, according to aspects of the disclosure. As illustrated, system 100 may include a plurality of host devices 110 that are coupled via a communications network 120 to a storage system 130, a storage system 140, and a management system 150. Each of the host devices 110 may include one or more of a desktop computer, a smartphone, a laptop, and/or any other suitable type of computing device. For example, in some implementations, any of the host devices 110 may be the same or similar to the computing device 600, which is discussed further below with respect to FIG. 6. The communications network 120 may include one or more of a local area network (LAN), a wide area network (WAN), a wireless network, a cellular network, a 5G network, the Internet, an InfiniBand network, and/or any other suitable type of network.

Management system 150 may be configured to perform various tasks related to the management of storage systems 130 and 140, including the allocation of storage space to applications and users, data organization and classification, data protection and backup, performance monitoring and optimization, capacity planning, and security and access control. Moreover, management system 150 may be configured to perform various tasks related to the orchestration of the snapshot process, such as snapshot scheduling, setting rules for how many snapshots to keep at any given time, keeping track of snapshot creation, deletion, and storage uses, as well as enabling automated processes for snapshot creation and management. The management system 150 may include any suitable type of computing device, such as the computing device 600, which is discussed further below with respect to FIG. 6. Although, in the example of FIG. 1, management system 150 is depicted as being independent of storage systems 130 and 140, in some implementations, management system 150 may be integrated with storage system 130 or storage system 140.

Storage system 130 may include any suitable type of storage system. By way of example, storage system 130 may be a content-addressable or a location-addressable storage system. In some implementations, storage system 130 may be the same or similar to storage system 200, which is discussed further below. Storage system 140 may include any suitable type of storage system. By way of example, storage system 140 may be a content-addressable or a location-addressable storage system. According to the present example, storage system 130 is a production storage system, and storage system 140 is a replication storage system, meaning that data stored in storage system 130 is also replicated in storage system 140.

Storage system 130 may store data volumes 135, 136, 137, and 138. Storage system 140 may store data volumes 145, 146, 147, and 148. According to the present example, volume 145 is a replica of volume 135; volume 136 is a replica of volume 146; volume 147 is a replica of volume 137; and volume 148 is a replica of volume 138. As used herein, the term “volume replica” refers to a duplicate copy of the volume that is created for various purposes, such as ensuring data availability, fault tolerance, and load balancing. The term “volume” refers to a logical unit of storage that is allocated to store files, applications, databases, and/or any other type of data.

According to the present example, volumes 135 and 145 are synchronized copies of a first volume (hereafter “volume 1”). Each of volumes 135 and 145 may be assigned a different volume ID, and viewed as a different “data structure” from an operating system-point-of-view, but ultimately, they may contain the same information. Specifically, the states of volumes 135 and 145 are synchronized, such that when data is written to volume 135 the same data is also copied into volume 145, and when data is deleted from volume 135 the same data is also deleted from volume 145.

According to the present example, volumes 136 and 146 are synchronized copies of a second volume (hereafter “volume 2”). Each of volumes 136 and 146 may be assigned a different volume ID, and viewed as a different “data structure” from an operating-system point-of-view, but ultimately, they may contain the same information. Specifically, the states of volumes 136 and 146 are synchronized, such that when data is written to volume 136 the same data is also copied into volume 146, and when data is deleted from volume 136 the same data is also deleted from volume 146.

According to the present example, volumes 137 and 147 are synchronized copies of a third volume (hereafter “volume 3”). Each of volumes 137 and 147 may be assigned a different volume ID and viewed as a different “data structure” from an operating-system point-of-view, but ultimately, they may contain the same information. Specifically, the states of volumes 137 and 147 are synchronized, such that when data is written to volume 137 the same data is also copied into volume 147, and when data is deleted from volume 137 the same data is also deleted from volume 147.

According to the present example, volumes 138 and 148 are synchronized copies of a fourth volume (hereafter “volume 4”). Each of volumes 138 and 148 may be assigned a different volume ID and viewed as a different “data structure” from an operating-system point-of-view, but ultimately, they may contain the same information. Specifically, the states of volumes 138 and 148 are synchronized, such that when data is written to volume 138 the same data is also copied into volume 148, and when data is deleted from volume 138 the same data is also deleted from volume 148.

Storage system 130 may generate and store snapshots 155 of volume 1 and snapshots 158 of volume 2. Each of snapshots 155 may be created based on volume 135 (which is the copy of volume 4 that is stored in storage system 130). Each of snapshots 158 may be created based on volume 138 (which is the copy of volume 4 that is stored in storage system 130). Storage system 140 may generate and store snapshots 156 of volume 2 and snapshots 157 of volume 3. Each of snapshots 156 may be created based on volume 146 (which is the copy of volume 2 that is stored in storage system 140). Each of snapshots 157 may be created based on volume 147 (which is the copy of volume 3 that is stored in storage system 140). In other words, either one of storage systems 130 and 140 may be arranged to generate snapshots of volumes whose copies are stored in both of storage system 130 and storage system 140. When one of storage systems 130 and 140 generates a snapshot of one of these volumes, the storage system may use its local copy of the volume to generate the snapshot.

Storage systems 130 and 140 may store instances of a snapshot location table 134. For example, instances of table 134 may be stored in the memory of one or more storage processors that are part of storage system 130 and/or one or more storage processors that are part of storage system 140. Table 134 may include one or more data structures that identify the storage system where the snapshots of each of volumes 1-4 is generated and stored. Although, in the present example, copies of table 134 are stored in the memory of storage systems 130 and 140, the present disclosure is not limited to any specific location for storing table 134. For instance, in some implementations, a single copy of table 134 may be stored in the memory of management system 150. Table 134 may be implemented as a search tree, an array, and/or any other suitable type of manner. FIG. 3 shows an example of table 134. As illustrated, table 3 may include a plurality of entries 302. Each entry 302 may include an identifier of a different volume (or storage group) in storage systems 130-140, as well as an indication of the storage system (e.g., one of storage systems 130-140) where snapshots of that volume are stored and generated.

Storage system 130 may be configured to execute a distributed snapshot policy (DSP) agent 161. The DSP agent 161 may be executed on one or more storage processors that are part of storage system 130. In one respect, DSP agent 161 may be configured to collect resource usage metrics for storage system 130. In one example, the collected resource usage metrics may include metrics that are indicative of the load that is placed on storage system 130 that are attributable to storage system having to generate and store snapshots. By way of example, such metrics may include the amount of CPU time that is consumed by the creation of snapshots, the amount of storage space that is used to store snapshots, the amount of storage space that is used to store snapshot metadata, and/or any other suitable metric that is indicative of the amount of overhead that is experienced by storage system 130 as a result of storage system 130 having to create and/or otherwise manage volume snapshots (e.g., snapshots of any of the volumes that are stored in storage system 130). Additionally or alternatively, in some implementations, the DSP agent 161 may be configured to collect resource usage metrics that are related to the general load that is being experienced by storage system 130. Such metrics may include a system write pending level for storage system 130 (e.g., how many write requests are currently pending at storage system), the rate at which I/O requests are received at storage system 130, the amount of CPU time and/or memory of storage system that is consumed by storage system 130 performing other tasks, such as servicing of I/O requests or performing garbage collection.

Storage system 140 may be configured to execute a distributed snapshot policy (DSP) agent 171. The DSP agent 171 may be executed on one or more storage processors that are part of storage system 140. In one respect, DSP agent 171 may be configured to collect resource usage metrics for storage system 140. In one example, the collected resource usage metrics may include metrics that are indicative of the load that is placed on storage system 140 because of storage system having to generate and store snapshots. By way of example, such metrics may include an amount of CPU time that is consumed by the creation of snapshots, amount of storage space that is used to store snapshots, amount of storage space that is used to store snapshot metadata, and/or any other suitable metric that is indicative of the amount of overhead that is experienced by storage system 140 as a result of storage system 140 having to create and/or otherwise manage volume snapshots (e.g., snapshots of any of the volumes that are stored in storage system 140). Additionally or alternatively, in some implementations, the DSP agent 171 may be configured to collect resource usage metrics that are related to the general load that is being experienced by storage system 140. Such metrics may include a system write pending level for storage system 140 (i.e., how many write requests are currently pending at storage system), the rate at which I/O requests are received at storage system 140, the amount of CPU time and/or memory of storage system that is consumed by storage system 140 performing other tasks, such as servicing of I/O requests or performing garbage collection.

DSP agents 161 and 171 may exchange the resource usage metrics they collect, such that each of DSP agents 161 and 171 would have the resource usage metrics for both of storage systems 130. DSP agent 171 may provide any metrics that it collects on storage system 140 to DSP agent 161, and DSP agent 161 may provide the metrics that it collects on storage system 130 to DSP agent 171.

In operation, DSP agent 161 may be configured to receive a command to create a snapshot and determine whether to execute the command or delegate the snapshot creation to storage system 140. The determination may be made in accordance with a policy rule 181. Policy rule 181 may be designed to balance the load associated with snapshot creation and management between storage systems 130 and 140. Ideally, policy rule 181 may ensure that storage systems 130 and 140 dedicate roughly the same amount of resources to the creation of snapshots of the volumes in storage systems 130 and 140. Additionally or alternatively, in some implementations, policy rule 181 may be selected to ensure that the creation and management of snapshots does not take system resources away from executing more important tasks, such as completing pending writes.

In operation, DSP agent 171 may be configured to receive a command to create a snapshot and determine whether to execute the command or delegate the snapshot creation to storage system 130. The determination may be made in accordance with a policy rule 191 rule. Policy rule 191 rule may be designed to balance the load associated with snapshot creation and management between storage systems 130 and 140. Ideally, policy rule 191 rule may ensure that storage systems 130 and 140 dedicate roughly the same amount of resources to the creation of snapshots of the volumes in storage systems 130 and 140. Additionally or alternatively, in some implementations, policy rule 191 rule may be selected to ensure that the creation and management of snapshots does not take system resources away from executing more important tasks, such as completing pending writes.

Each of policy rules 181 and 191 may provide that an incoming snapshot create command should be executed by one of storage systems 130 and 140 which currently dedicates less storage space to the storage of snapshots and/or snapshot metadata. In another example, each of policy rules 181 and 191 may provide that an incoming snapshot create command should be executed by one of storage systems 130 and 140 which currently has fewer writes pending and/or fewer incoming write requests. In yet another example, each of policy rules 181 and 191 may provide that an incoming snapshot create command should be executed by one storage systems 130 and 140, which currently dedicates less storage space to the storage of snapshots and/or snapshot metadata, provided that the writes pending at that storage system is less than a threshold. If the writes pending is above the threshold, the same policy rule may provide that the other storage system should create the snapshot. In yet another example, each of policy rules 181 and 191 may provide that snapshot create request should be executed by one of storage systems 130 and 140 which currently dedicates less resources to the creation and storage of snapshots and/or snapshot metadata. The amount of resources dedicated may be measured based on any of the metrics collected by DSP agents 161 and 171. For example, the amount or resources dedicated to the creation and storage of snapshots may be measured based on one or more of storage space that is dedicated to storing snapshots and snapshot metadata, random-access memory space that is needed for the creation of snapshots and snapshot metadata, CPU time that is spent on the creation of snapshots and snapshot metadata, and so forth.

It will be understood that the present disclosure is not limited to any specific policy rule. In general, any policy rule can be used that selects a storage system to execute a snapshot create command based on an outcome of a comparison between a first metric value (for storage system 130) that is collected by DSP agent 161 to a second DSP metric value (for storage system 140) that is collected by DSP agent 171. As noted above, in some implementations, the outcome of the comparison may indicate which storage system is dedicating fewer resources to the creation, storage, and/or management of snapshots. The phrase “a comparison between a first metric value (for storage system 130) that is collected by DSP agent 161 to a second DSP metric value (for storage system 14) that is collected by DSP agent 161” may refer to comparing the first metric to the second metric or comparing a first set of metrics (for storage system 130) of which the first metric is part to a second set of metrics (for storage system 140) of which the second metric is part.

Storage system 130 may store a DSP-enabled setting 162. Setting 162 may be a variable (e.g., a Boolean variable) that is used to override the action of DSP agent 161. When setting 162 is set to a first value (e.g., false), storage system 130 may be required to execute any received snapshot create commands. When setting 162 is set to a second value (e.g., true), storage system 130 may use DSP agent 161 to determine which one of storage systems 130 and 140 is going to execute incoming snapshot commands. In other words, the use of DSP agent 161 to determine the storage system that would execute an incoming snapshot create command may be contingent upon the value of setting 162.

Storage system 140 may store a DSP-enabled setting 172. Setting 172 may be a variable (e.g., a Boolean variable) that is used to override the action of DSP agent 171. When setting 172 is set to a first value (e.g., false), storage system 140 may be required to execute any received snapshot create commands. When setting 172 is set to a second value (e.g., true), storage system 140 may use DSP agent 171 to determine which one of storage systems 130 and 140 is going to execute incoming snapshot commands. In other words, the usage of DSP agent 171 to determine the storage system that would execute an incoming snapshot create command may be contingent upon the value of setting 172.

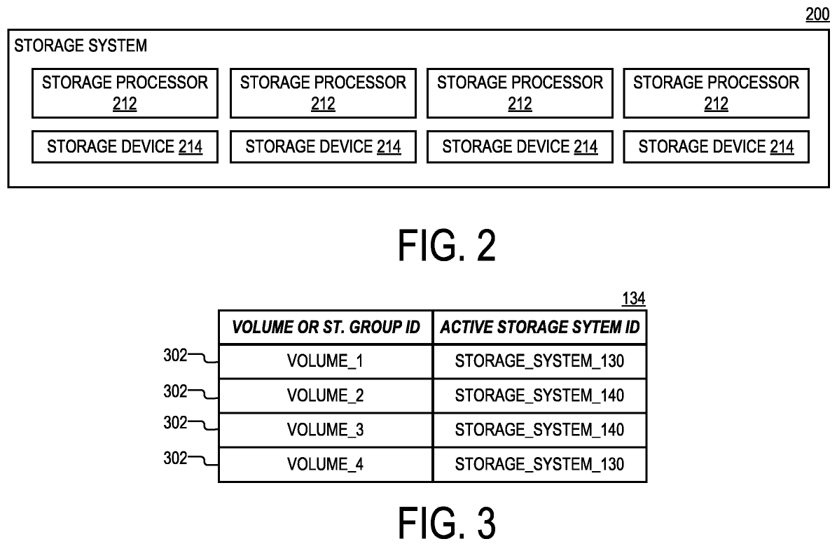

FIG. 2 shows an example of a storage system 200, according to aspects of the disclosure. As illustrated, storage system 200 may include a plurality of storage processors 212 and a plurality of storage devices 214. Each of the storage processors 212 may include a computing device that is configured to receive I/O requests (e.g., read or write requests, etc.) from any of the host devices 110 and execute the received I/O requests by reading or writing data to the storage devices 214. In some implementations, each of the storage processors 212 may have an architecture that is the same or similar to the architecture of the computing device 600, which is shown in FIG. 6. Each of the storage devices 214 may include any of a solid-state drive (SSD), a non-volatile random-access memory (nvRAM) device, a non-volatile memory express (NVME) device, a hard disk (HD), and/or any other suitable type of storage device. In some implementations, the storage devices 214 may be arranged in one or more Redundant Array(s) of Independent Disks (RAID) arrays.

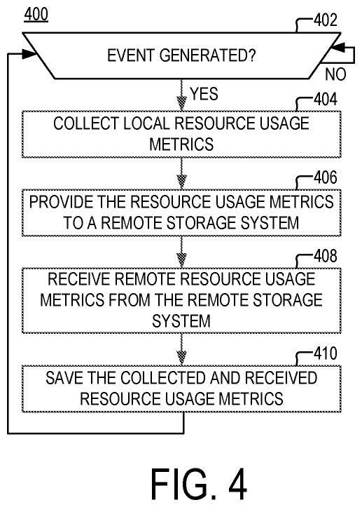

FIG. 4 is a flowchart of an example of a process 400, according to aspects of the disclosure. According to the present example, process 400 is performed by DSP agent 161. However, alternative implementations are possible in which process 400 is executed by DSP agent 171 or another entity.

At step 402, DSP agent 161 detects whether one or more predetermined events have been generated. In one example, the DSP agent 161 may detect whether a timer event is generated. The timer event may be generated periodically by a timer to trigger the collection of resource usage metrics. Additionally or alternatively, DSP may detect whether a snapshot create event is detected. The snapshot create event may be generated when a snapshot create command is received at storage system 130 and/or agent 161. If any of these events are generated, process 400 proceeds to step 404. Otherwise, step 402 is repeated.

At step 404, DSP agent 161 collects resource usage metrics for storage system 130. The collected resource usage metrics may include any of the metrics that are discussed above with respect to FIG. 1.

At step 406, DSP agent 161 provides the collected resource usage metrics to DSP agent 171.

At step 408, DSP agent 161 receives resource usage metrics that are collected by DSP agent 171 for storage system 140. The resource usage metrics for storage system 140 may be received from DSP agent 171. The resource usage metrics for storage system 140 may include any of the resource usage metrics that are discussed above with respect to FIG. 1.

At step 410, DSP agent 161 stores the collected and received resource usage metrics in a memory that is part of storage system 130. In one example, the resource usage metrics may be stored in the memory of the same storage processor (or other computing device) that is executing the DSP agent 161. However, the present disclosure is not limited to any specific location for storing the resource usage metrics.

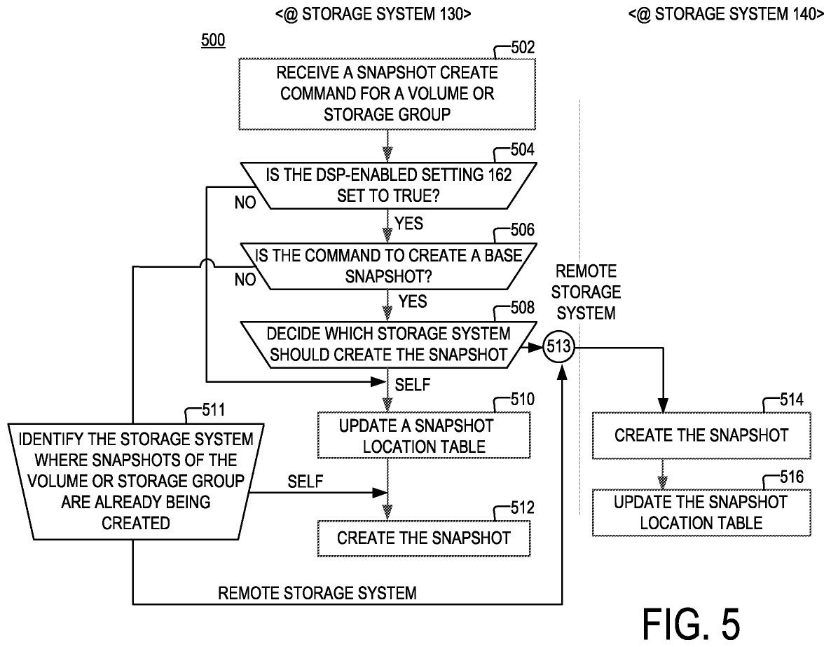

FIG. 5 is a flowchart of an example of a process 500, according to aspects of the disclosure.

At step 502, DSP agent 161 receives a snapshot create command. The snapshot create command may be received from management system 150 and/or any other entity. The snapshot create command may include any command that triggers the creation of a snapshot of a volume (hereinafter “corresponding volume”). The snapshot create command may include an identifier of the corresponding volume.

At step 504, DSP agent 161 detects if the setting 162 is set to true. If setting 162 is set to true, process 500 proceeds to step 506. Otherwise, process 500 proceeds to step 510.

At step 506, DSP agent 161 determines if the command is to create a base snapshot. If a determination is made that the command is to create a base snapshot (or, put differently, if it is determined that the snapshot created in response to the command would be a base snapshot), process 500 proceeds to step 508. Otherwise, process 500 proceeds to step 511.

At step 508, DSP agent 161 decides which one of storage systems 130 and 140 should execute the snapshot create command (received at step 502). If DSP agent 161 determines that storage system 130 should create the snapshot that is requested by the command (received at step 502), process 500 proceeds to step 510. Otherwise, if DSP agent 161 determines that storage system 140 should create the snapshot that is requested by the command (received at step 502) process 500 proceeds to step 513.

The determination, at step 508, of which storage system should create the snapshot may be made by evaluating policy rule 181 (shown in FIG. 1). Policy rule 181 may be evaluated based on resource usage metrics for storage system 130 and resource usage metrics that for storage system 140 that are collected by DSP agents 161 and 171, respectively. The resource usage metrics may be the same or similar to the resource usage metrics that are discussed above with respect to FIGS. 1 and 4. According to one example, DSP agent 161 compares a first resource usage metric for storage system 130 to a second resource usage metric for storage system 140 and assigns one of the storage systems 130 and 140 which has the lower resource usage. For example, the first resource usage metric may be the amount of storage space that is used by storage system 130 for the creation and management of snapshots (i.e., snapshots of any of the volumes that are stored in storage system 130). The second resource usage metric may be the amount of storage space that is used by storage system 140 for the creation and management of snapshots (i.e., snapshots of any of the volumes that are stored in storage system 140). In this example, the DSP agent 161 may assign the creation of the snapshot to one of storage systems 130 and 140 which is currently using a smaller amount of storage space to store and manage snapshots. However, it will be understood that the present disclosure is not limited to using any specific policy rule for selecting the storage system that would create the snapshot.

At step 510, DSP agent 161 updates the snapshot location table 134 to indicate that storage system 130 is tasked with creating snapshots of the corresponding volume (i.e., the volume whose snapshot is requested to be created) and that snapshots of the corresponding volume are stored in storage system 130. Updating the snapshot location table 134 may include creating a new entry 302, inserting in the new entry 302 an identifier of the corresponding volume, inserting in the new entry an identifier of storage system 130, adding the new entry into one or more local instances of table 134 that are stored in storage system 130, and synchronizing those the local instances with other instances of table 134 that are stored in storage system 140. As used in the context of step 510, the phrase “storage system 130 is tasked with creating snapshots of the corresponding volume” means that storage system 130 would be the location where snapshots of the corresponding volume would be created, starting with the snapshot that is requested at step 502.

At step 511, DSP agent 161 consults snapshot location table 134 to identify the storage system that is presently tasked with creating snapshots of the corresponding volume, and where snapshots of the corresponding volume are stored. In some implementations, DSP agent 161 may perform a search of table 134 to identify an entry 302 that includes an identifier of the corresponding volume. Afterwards, DSP agent 161 retrieves an identifier of a storage system from the retrieved entry 302. If the retrieved identifier belongs to storage system 130, DSP agent 161 determines that storage system 130 is presently tasked with creating snapshots of the corresponding volume, and process 500 proceeds to step 512. If the retrieved identifier belongs to storage system 130, DSP agent 161 determines that storage system 130 is presently tasked with creating snapshots of the corresponding volume, and process 500 proceeds to step 512. Otherwise, if the retrieved identifier belongs to storage system 140, DSP agent 161 determines that storage system 140 is presently tasked with creating snapshots of the corresponding volume, and process 500 proceeds to step 513. As used in the context of step 511, the phrase “presently tasked with creating snapshots of the corresponding volume” means that the storage system has already created one or more snapshots of the corresponding volume before the receipt of the snapshot create command at step 502.

At step 512, a snapshot of the corresponding volume is created by storage system 130 and subsequently stored in one or more storage devices that are part of storage system 130. The snapshot may be created by the same storage processor (or other computing device) that is executing the DSP agent 161 or it may be created by another storage processor (or computing device) that is part of storage system 130.

At step 513, DSP agent 161 transmits to DSP agent 171 an instruction to create a snapshot of the corresponding volume. The instruction, when received by DSP agent 171, causes DSP agent 171 to trigger the creation of the snapshot by one or more storage processors (or other computing devices) that are part of storage system 140.

At step 514, a snapshot of the corresponding volume is created by storage system 140 and subsequently stored in one or more storage devices that are part of storage system 140. The snapshot may be created by one or more storage processors (or other computing devices) that are part of storage system 140. The snapshot may be created in response to the instruction transmitted at step 513.

At step 516, DSP agent 171 updates the snapshot location table 134 to indicate that storage system 140 is tasked with creating snapshots of the corresponding volume (i.e., the volume whose snapshot is requested to be created) and that snapshots of the corresponding volume are stored in storage system 130. Updating the snapshot location table 134 may include creating a new entry 302, inserting in the new entry 302 an identifier of the corresponding volume, inserting in the new entry an identifier of storage system 140, adding the new entry into one or more local instances of table 134 that are stored in storage system 140, and synchronizing the local instances of table 134 with other instances of table 134 that are stored in storage system 130. As used in the context of step 516, the phrase “storage system 140 is tasked with creating snapshots of the corresponding volume” means that storage system 140 would be the location where snapshots of the corresponding volume would be created, starting with the snapshot that is requested at step 502. As can be readily appreciated, step 516 may be omitted when the snapshot location table 134 has already been updated to indicate that storage system 140 is tasked with creating snapshots of the corresponding volume. In other words, step 516 may be executed only once, when storage system 140 is initially assigned to create snapshots of the corresponding volume.

A snapshot is a point-in-time copy of a volume or storage group. In many applications, snapshots are created periodically (e.g., every hour). The snapshots are sequential in nature. Consider an example in which a first, second, and third snapshots of a volume are created. The first snapshot of the volume (taken at time t1) may include a copy of the volume. The second snapshot of the volume (taken at time t2) may reflect only the changes that were made to the volume between times t1 and t2—in other words, it may represent the difference between the states of the volume at times t1 and t2 while excluding information that remains the same. The third snapshot of the volume (taken at time t3) may reflect only the changes that were made to the volume between times t2 and t3—in other words, it may represent the difference between the states of the volume at times t2 and t3 while excluding information that remains the same. When the state of the volume at time t3 needs to be restored, this requires all snapshots up to the first snapshot to be used (because later snapshots would not contain information that had remained unchanged). In the present example, the first, second, and third snapshots are needed to restore the state of the volume at time t3. In the present example, the first volume is a base volume—i.e., because it is the first volume in a sequence of snapshots and/or because it is the oldest snapshot that is needed to restore the state of the volume.

As used herein, the term “base snapshot” refers to the earliest snapshot of a volume that is needed to restore the state of a data volume at a particular time instance. In many storage systems, snapshots are given sequence numbers. In general, in a sequence of snapshots, the snapshot bearing the first sequence number (e.g., ‘1’) is considered to be the base snapshot. However, it is hypothetically possible that the sequence of snapshots may be restarted by making a later snapshot a base snapshot (i.e., by making the later snapshot a full copy of a data volume rather than a diff).

DSP agent 161 may determine in any suitable manner (at step 506) whether the command (received at step 502) is to create a base snapshot. For example, in some instances, DSP agent 161 may retrieve a sequence number for the snapshot from the request, and if the sequence number has a predetermined value (e.g., ‘1’), DSP agent 161 may determine that the snapshot create command is to create a base snapshot. In another example, DSP agent 161 may perform a search of the table 134 to determine if the volume (or storage group) that is associated with the snapshot create command is already mapped to a particular storage system. If the volume is already mapped to a particular storage system, that may serve as an indication that snapshots for the volume are already being created at one of storage systems 130 and 140, which in turn would indicate that the command is not a command to create a base snapshot. As another example, rather than using table 134, the DSP agent 161 may use a different approach for determining if snapshots of the volume are already being created at one of storage systems 130 and 140; if none of storage systems 130 and 140 has previously created a snapshot of the volume, DSP agent 161 may determine that the command (received at step 502) is to create a base snapshot; if one storage systems 130 and 140 has already created and stored one or more snapshots of the volume before the command is received, DSP agent 161 may determine that the command is not to create a base snapshot. It will be understood that the present disclosure is not limited to any specific method for determining whether the snapshot create command (received at step 502) requires storage system 130 to create a base snapshot of a volume (or storage group). The phrase “command to create a base snapshot” does not necessarily mean that there are different commands to create base snapshots and non-base snapshots. Rather, it means that the snapshot created in response to the command would be a base snapshot (e.g., the first snapshot in a sequence of snapshots for the same volume and/or storage group). Depending on the circumstances, the same command may or may not be a command to create a base snapshot.

Process 500 receives a command to create a given snapshot (at step 502) and selects one of a plurality of storage systems as a location where the given snapshot should be created. In the example, of FIG. 5, the plurality of storage systems includes two storage systems, however alternative implementations are possible in which the plurality includes more than two storage systems. In such implementations, each storage system in the plurality may store a copy of the volume or storage group whose snapshot is requested to be created. Each storage system may be provided with a DSP agent, such as agents 161 and 171. Each DSP agent may collect one or more resource usage metrics for its respective storage system. Each DSP agent may provide the collected resource usage metrics to the rest of the other storage systems in the plurality. Each DSP agent may receive resource usage metrics that are collected by the other DSP agents. The selection of one of the plurality of storage systems may be performed based on a storage rule, such as the policy rules 181 and 191. The policy rule may be evaluated by comparing a plurality of resource usage metrics, where each resource usage metric belongs to a different one of the plurality of storage systems. In one example, the policy rule may provide that the storage system that is dedicating the least amount of resources to the creation and/or management of snapshots should be the location where the given snapshot is created.

FIG. 6 is a diagram of an example of a device 600. The device 600 may be the same or similar to any of the storage processors in storage system 130 and/or storage system 140. In some embodiments, device 600. may include processor 602, volatile memory 604 (e.g., RAM), non-volatile memory 606 (e.g., a hard disk drive, a solid-state drive such as a flash drive, a hybrid magnetic and solid-state drive, etc.), graphical user interface (GUI) 608 (e.g., a touchscreen, a display, and so forth) and input/output (I/O) device 620 (e.g., a mouse, a keyboard, etc.). Non-volatile memory 606 stores computer instructions 612, an operating system 616 and data 618 such that, for example, the computer instructions 612 are executed by the processor 602 out of volatile memory 604. Program code may be applied to data entered using an input device of GUI 608 or received from I/O device 620.

FIGS. 1-6 are provided as an example only. For ease of description, the examples of FIGS. 1-6 involve the creation of snapshots of individual volumes. However, it will be understood that the concepts and ideas presented herein can be extended to the creation of snapshots of storage groups. A storage group is a set of two or more volumes. Storage groups may be treated in the same way as individual volumes as far as the examples of FIGS. 1-6 are concerned. For example, the command received at step 502 (shown in FIG. 5) may include an identifier of a storage group whose snapshot is desired to be created instead of an identifier of an individual data volume. Similarly, any of the entries 302 of table 134 (shown in FIG. 3) may include an identifier of a storage group instead of an identifier of an individual volume. The phrase “executed by a storage system” shall mean executed on one or more storage processors or other computing devices that are part of the storage system. The phrase “received by a storage system” shall mean received by one or more storage processors or other computing devices that are part of the storage system.

In some embodiments, an I/O request may refer to a data read or write request. At least some of the steps discussed with respect to FIGS. 1-6 may be performed in parallel, in a different order, or altogether omitted. As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. The term “processing circuitry” as used throughout the specification may refer to one or more of a general-purpose processor (e.g., an x86 processor, an ARM-based processor, or a RISC-V processor), a field programmable gate array (FPGE), an application-specific integrated circuit (ASIC), and/or any other suitable type of electronic circuitry. The term “malware” may refer to any software designed to exploit a computer system, a computer network, or a user. Examples of malware include viruses, worms, Trojans, ransomware, spyware, adware.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

To the extent directional terms are used in the specification and claims (e.g., upper, lower, parallel, perpendicular, etc.), these terms are merely intended to assist in describing and claiming the invention and are not intended to limit the claims in any way. Such terms do not require exactness (e.g., exact perpendicularity or exact parallelism, etc.), but instead it is intended that normal tolerances and ranges apply. Similarly, unless explicitly stated otherwise, each numerical value and range should be interpreted as being approximate as if the word “about”, “substantially” or “approximately” preceded the value of the value or range.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Although the subject matter described herein may be described in the context of illustrative implementations to process one or more computing application features/operations for a computing application having user-interactive components the subject matter is not limited to these particular embodiments. Rather, the techniques described herein can be applied to any suitable type of user-interactive component execution management methods, systems, platforms, and/or apparatus.

While the exemplary embodiments have been described with respect to processes of circuits, including possible implementation as a single integrated circuit, a multi-chip module, a single card, or a multi-card circuit pack, the described embodiments are not so limited. As would be apparent to one skilled in the art, various functions of circuit elements may also be implemented as processing blocks in a software program. Such software may be employed in, for example, a digital signal processor, micro-controller, or general-purpose computer.

Some embodiments might be implemented in the form of methods and apparatuses for practicing those methods. Described embodiments might also be implemented in the form of program code embodied in tangible media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the claimed invention. Described embodiments might also be implemented in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the claimed invention. When implemented on a general-purpose processor, the program code segments combine with the processor to provide a unique device that operates analogously to specific logic circuits. Described embodiments might also be implemented in the form of a bitstream or other sequence of signal values electrically or optically transmitted through a medium, stored magnetic-field variations in a magnetic recording medium, etc., generated using a method and/or an apparatus of the claimed invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments.

Also, for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

It will be further understood that various changes in the details, materials, and arrangements of the parts which have been described and illustrated in order to explain the nature of the claimed invention might be made by those skilled in the art without departing from the scope of the following claims.

1. A method, comprising:
collecting, by a distributed snapshot policy (DSP) agent that is executed in a first storage system, a first resource usage metric of the first storage system, the first storage system being configured to store a copy of a storage entity, the storage entity being a volume or a storage group, the first resource usage metric including a measure of writes pending at the first storage system;
receiving, by the DSP agent, a respective second resource usage metric for each of one or more second storage systems, each of the second storage systems also being configured to store a copy of the storage entity, each respective second resource usage metric including a measure of writes pending at a different one of the second storage systems;
detecting, by the DSP agent, that a given snapshot of the storage entity needs to be created;
detecting, by the DSP agent, whether the given snapshot would be a base snapshot;
selecting, by the DSP agent, one of the first and second storage systems as a location where the given snapshot should be created, the location being selected based on whether the given snapshot would be a base snapshot, such that: (i) when the given snapshot would be a base snapshot, the location is selected by evaluating a policy rule based on the first and second resource usage metrics, and (ii) when the given snapshot would not be a base snapshot, the location is selected by identifying the location where snapshots of the storage entity are already being created, without evaluating the policy rule; and
generating the given snapshot by one of the first storage system and the second storage systems that is selected as the location where the given snapshot should be created,
wherein the policy rule is arranged to balance a load associated with snapshot creation between the first storage system and the second storage system, the balancing being based on the first resource usage metric, any of the second resource usage metrices, and respective amounts of resources that are dedicated by each of the first and second storage systems to the creation and storage of snapshots.

2. The method of claim 1, wherein the policy rule provides that the given snapshot should be created by one of the first and second storage systems which currently dedicates the least storage space to the storage of snapshots and/or snapshot metadata, provided that the writes pending at the storage system is less than a threshold.

3. (canceled)

4. The method of claim 1, wherein the given snapshot would be a base snapshot when the given snapshot is a first snapshot in a sequence of snapshots.

5. The method of claim 1, wherein the given snapshot would be a base snapshot when none of the first and second storage systems has commenced taking snapshots of the storage entity.

6-7. (canceled)

8. The method of claim 1, wherein the identifying of the location where snapshots of the storage entity are already being created is performed based on a data structure, the data structure identifying a plurality of storage entities that have copies stored in each of the first and second storage systems, for each one of the plurality of storage entities, the data structure identifying a respective one of the first and second storage systems as a storage system where snapshots of the storage entity are being created.

9. A computing device, comprising:
a memory; and
at least one processor that is operatively coupled to the memory, the at least one processor being configured to perform the operations of:
collecting, by a distributed snapshot policy (DSP) agent, a first resource usage metric of a first storage system, the first storage system being configured to store a copy of a storage entity, the storage entity being a volume or a storage group, the first resource usage metric including a measure of writes pending at the first storage system;
receiving, by the DSP agent, a respective second resource usage metric for each of one or more second storage systems, each of the second storage systems also being configured to store a copy of the storage entity, each respective second resource usage metric including a measure of writes pending at a different one of the second of the second storage systems;
detecting, by the DSP agent, that a given snapshot of the storage entity needs to be created;
detecting, by the DSP agent, whether the given snapshot would be a base snapshot;
selecting, by the DSP agent, one of the first and second storage systems as a location where the given snapshot should be created, the location being selected based on whether the given snapshot would be a base snapshot, such that: (i) when the given snapshot would be a base snapshot, the location is selected by evaluating a policy rule based on the first and second resource usage metrics, and (ii) when the given snapshot would not be a base snapshot, the location is selected by identifying the location where snapshots of the storage entity are already being created, without evaluating the policy rule; and
causing, by the DSP agent, the given snapshot to be created at one of the first storage system and the second storage system that is selected as the location where the given snapshot should be created,
wherein the policy rule is arranged to balance a load associated with snapshot creation between the first storage system and the second storage system, the balancing being based on the first resource usage metric, the second resource usage metric, and respective amounts of resources that are dedicated by each of the first and second storage systems to the creation and storage of snapshots.

10. The computing device of claim 9, wherein the policy rule provides that the given snapshot should be created by one of the first and second storage systems which currently dedicates the least storage space to the storage of snapshots and/or snapshot metadata, provided that the writes pending at the storage system is less than a threshold.

11. (canceled)

12. The computing device of claim 9, wherein the given snapshot would be a base snapshot when the given snapshot is a first snapshot in a sequence of snapshots.

13. The computing device of claim 9, wherein the given snapshot would be a base snapshot when none of the first and second storage systems has commenced taking snapshots of the storage entity.

14-15. (canceled)

16. The computing device of claim 9, wherein the identifying of the location where snapshots of the storage entity are already being created is performed based on a data structure, the data structure identifying a plurality of storage entities that have copies stored in each of the first and second storage systems, for each one of the plurality of storage entities, the data structure identifying a respective one of the first and second storage systems as a storage system where snapshots of the storage entity are being created.

17. A non-transitory computer-readable medium storing one or more processor-executable instructions, which, when executed by at least one processor, cause the at least one processor to perform the operations of:
collecting, by a distributed snapshot policy (DSP) agent, a first resource usage metric of a first storage system, the first storage system being configured to store a copy of a storage entity, the storage entity being a volume or a storage group, the first resource usage metric including a measure of writes pending at the first storage system;
receiving, by the DSP agent, a respective second resource usage metric for each of one or more second storage systems, each of the second storage systems also being configured to store a copy of the storage entity, each respective second resource usage metric including a measure of writes pending at a different one of the second storage systems;
detecting, by the DSP agent, that a given snapshot of the storage entity needs to be created;
detecting, by the DSP agent, whether the given snapshot would be a base snapshot;
selecting, by the DSP agent, one of the first and second storage systems as a location where the given snapshot should be created, the location being selected based on whether the given snapshot would be a base snapshot, such that: (i) when the given snapshot would be a base snapshot, the location is selected by evaluating a policy rule based on the first and second resource usage metrics, and (ii) when the given snapshot would not be a base snapshot, the location is selected by identifying the location where snapshots of the storage entity are already being created, without evaluating the policy rule; and
causing the given snapshot to be created at one of the first storage system and the second storage system that is selected as the location where the given snapshot should be created,
wherein the DSP agent is executed in the first storage system wherein and the policy rule is arranged to balance a load associated with snapshot creation between the first storage system and the second storage systems, the balancing being based on the first resource usage metric, the second resource usage metric, and respective amounts of resources that are dedicated by each of the first and second storage systems to the creation and storage of snapshots.

18. The non-transitory computer-readable medium of claim 17, wherein the policy rule provides that the given snapshot should be created by one of the first and second storage systems which currently dedicates the least storage space to the storage of snapshots and/or snapshot metadata, provided that the writes pending at that storage system is less than a threshold.

19-20. (canceled)

21. The method of claim 1, wherein selecting, by the DSP agent, one of the first and second storage systems as the location where the given snapshot should be created includes:
when the first storage system is selected, updating a snapshot location data structure, by the first storage system, to indicate that the first storage system is tasked with creating snapshots of the storage entity, and
when any given one of the second storage systems is selected, transmitting from the first storage system to the given second storage system an instruction to create the given snapshot, and updating a snapshot location data structure, by the given second storage system, to indicate that the first storage system is tasked with creating snapshots of the storage entity.
